(19) United States
(12) Patent Application Publication
(10) Pub. No.: US 2013/0153345 A1
(43) Pub. Date: Jun. 20, 2013

(54) BRAKE ELEMENT

(71) Applicants: Hagen KUCKERT, Bietigheim-Bissingen (DE); Patrick GLASER, Stuttgart (DE)

(72) Inventors: Hagen KUCKERT, Bietigheim-Bissingen (DE); Patrick GLASER, Stuttgart (DE)

(73) Assignee: Robert Bosch GmbH, Stuttgart (DE)

(21) Appl. No.: 13/720,666

(22) Filed: Dec. 19, 2012

(30) Foreign Application Priority Data
Dec. 20, 2011 (DE) 10 2011 089 125.0

(51) Int. Cl. F16D 65/12

(52) U.S. Cl. CPC F16D 65/127; F16D 65/125
USPC 188/218 XL

(57) ABSTRACT

A brake disc for a disk brake of a motor vehicle is made of cast iron and lamellar graphite. The graphite is removed from open cavities of the cast iron, e.g., by an ultrasound treatment, in order to improve an adhesion of a thermal powder coating subsequently applied on friction surfaces of the brake disk.

### BACKGROUND OF THE INVENTION

1. Field of the Invention

The present invention relates to a brake element for a friction brake of a land vehicle, e.g., a motor vehicle.

2. Description of the Related Art

The brake element is a rotatable component, for instance a brake drum or a brake disk, which is able to be braked by the friction brake, e.g., a brake disk for a disk brake of a motor vehicle or other land vehicle. Brake elements have one or more friction surface(s). These are surfaces against which a friction brake lining or similar component of a friction brake is pressed during a braking operation and for braking the brake element. A brake disk typically has two circular ring-shaped friction surfaces on end faces that are facing away from each other.

Brake elements, e.g., brake disks made of gray cast iron including lamellar graphite are already known. The friction surfaces of the known brake elements usually are machined, which removes a so-called outer crust and cuts into cavities. The cavities are irregularly shaped hollow spaces which contain the lamellar graphite.

### BRIEF SUMMARY OF THE INVENTION

The brake element according to the present invention has friction surfaces which are coated, i.e., provided with a surface coating. It is also possible that surface regions abutting the friction surface/s and/or other surface regions or even the entire surface of the brake element is/are coated. For example, the coating is used to increase wear and the corrosion resistance, and/or to increase the friction coefficient between the brake element and a friction brake lining. Preferably, the coating is a thermal and/or powder coating. A powder coating means that a coating material is a powder in its original form, which melts prior to or during the application on the brake element, combines with the brake element and forms a surface layer on the brake element. The term ‘thermal’ denotes heating of the powder to at least a melting temperature, prior to or during the coating operation. For example, the powder is applied on the brake element by flame-spraying.

There arises the problem that the lamellar graphite of the cast iron of the brake element is freely exposed because of the machining of its friction surface/s and the graphite-containing cavities which were cut into during the machining. The exposed graphite at the cut cavities has a detrimental effect on an adherence of the coating; the coating practically does not adhere at the cut cavities and the exposed graphite.

Therefore, the present invention provides a decreasing graphite component of the cast iron in the area of the friction surface of the brake body, close to a surface of the brake element in the direction of the surface of the brake element. The graphite component, which essentially is constant in the cast iron, thus decreases near the surface to zero, virtually zero or at least to a low value, at the surface in the region of the friction surface of the brake element.

Another option consists of sealing graphite-containing cavities of the cast iron of the brake element in the region of the friction surface/s, which cavities had been cut into by the machining of the friction surface/s and thus are open, before applying the coating on the surface of the brake element. Both options may be realized individually, by themselves; preferably, they are realized jointly, so that, in particular, the graphite component in the region of the friction surface first is reduced in the direction of the surface, and the cavities are then sealed in a subsequent step. Both measures improve the adhesion of the coating subsequently applied on the brake element at least in the region of the friction surface; lamellar graphite or cavities which are cut into or are open do not reduce or cancel the adhesion of the coating in certain spots.

The advantage of the present invention is an improved adhesion of the coating of the brake element, the coating adhering across its entire surface in uniform manner and without missed spots.

According to one embodiment of the present invention, the brake element is subjected to an ultrasound treatment, at least in the region of the friction surface. The ultrasound treatment, for example, may be carried out in a liquid bath or by placing an ultrasonic exciter, a so-called sonotrode, on top. The ultrasound treatment is carried out like an ultrasonic cleaning, in which graphite from open cavities is at least partially detached and removed, at least in a region near the surface. The ultrasound treatment reduces the graphite component in the cast iron of the brake element in the desired manner in a near-surface region in the direction of the surface. The near-surface region is delimited by a depth of the graphite-containing cavities of the cast iron of the brake element that were cut into and opened during the machining of the friction surface/s of the brake element.

An example embodiment of the present invention provides a mechanically treated friction surface or surfaces of the brake element. The treatment, for instance, uses abrasive blasting such as sandblasting or shot peening, in order to close open cavities. Preferably, the blasting is not meant to smooth but rather to roughen the surface of the brake element, in order to improve the adhesion of the coating. It is also possible to close the cavities and to increase the surface roughness by selecting suitable blasting means and blasting parameters, such as a blasting rate and a blasting angle.

An example embodiment of the present invention provides a surface of the brake element in the region of the friction surface/s that was subjected to a laser beam treatment. The laser beam treatment sublimates the graphite of the cast iron on and near the surface, and the cast iron is fused at the surface and thereby closes the cavities. The laser beam treatment also makes it possible to increase a surface roughness of the cast iron of the brake element.

### BRIEF DESCRIPTION OF THE DRAWINGS

FIG. 1 shows a perspective view of a brake element according to the present invention, with a section removed.

FIG. 2 shows an enlargement of a cutaway section according to detail II in FIG. 1.

### DETAILED DESCRIPTION OF THE INVENTION

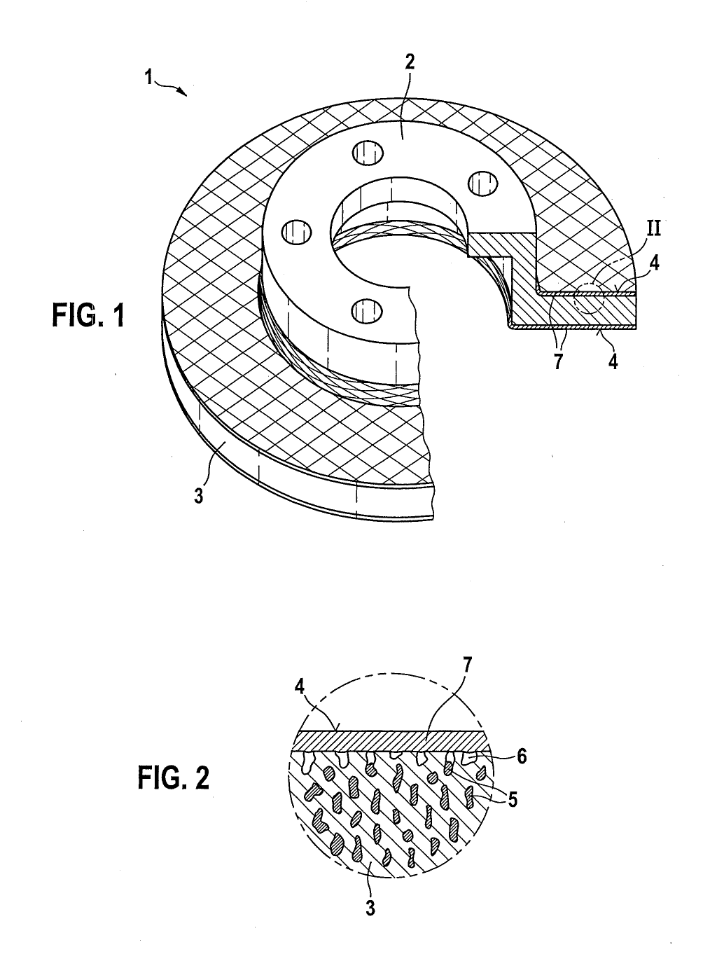

FIG. 1 shows a brake disk 1, which forms a brake element according to the present invention. Brake disk 1 is intended for a disk brake of a motor vehicle (not shown). It has a cup-shaped hub 2 provided with a disk-shaped collar 3, whose two end faces form friction surfaces 4. For braking, friction brake pads (not shown) are pressed against friction surfaces 4 from both sides and thereby brake the brake disk 1 in the known manner.

Brake disk 1 is made of cast iron containing graphite flakes, friction surfaces 4 are machined, that is to say, turned on a lathe, i.e., thin surface layers have been removed from friction surfaces 4 by a machining process. The machining of friction surfaces 4 has cut into, i.e., opened, cavities 6 (FIG. 2) of the cast iron of brake disk 1, which cavities contain flake graphite of the cast iron, i.e., graphite in the form of irregular flakes. An ultrasound treatment may be used to remove the graphite completely or at least partially from cavities 6 which were cut into, that is to say, which reach up to the surface. The ultrasound treatment is performed in the manner of an ultrasonic cleaning, for instance using a sonotrode placed on top, i.e., a tool that introduces high-frequency mechanical vibrations, i.e., ultrasound, of an ultrasound generator into brake disk 1, or it takes place in a liquid bath in which the liquid is subjected to an ultrasound application. The ultrasonic vibrations introduced into the cast iron of brake disk 1 destroy the graphite flakes and detach them from cavities 6 that were cut into and thus opened by the machining. Graphite from deep cavities 6 is possibly removed only partially. The ultrasound application is restrictable to the region of friction surfaces 4.

FIG. 2 shows a sectional view of the cast iron including lamellar graphite particles 5 in a near-surface region in the area of a friction surface 4 of brake disk 1. Cavities 6 not cut into remain fully filled with lamellar graphite 5. Cut-into cavities 6 are completely free of graphite, or deeper cavities 6 are partially free of graphite. This means that the proportion of lamellar graphite 5 in the cast iron of brake disk 1 is constant across a large portion of a thickness of brake disk 1, and decreases, preferably down to zero, in a near-surface region in the direction of a surface of brake disk 3 in the area of friction surfaces 4. The near-surface region in which the graphite component decreases or is lower than in rest of the cast iron, reaches from the surface to the depth of cavities 6 that were cut into by the machining of friction surfaces 4.

Following the ultrasound treatment, a mechanical treatment of the surfaces of friction surfaces 4 of brake disk 1 takes place, for instance a sand blasting or shot blasting treatment. This closes the cut-into cavities 6, so that the cast iron of brake disk 1 in the region of friction surfaces 4 has a sealed surface. At the same time the surface is roughened, i.e., a surface roughness is increased.

A thermal powder coating 7 is then applied to friction surfaces 4 treated in such a manner, e.g., by flame spraying. Powder coating 7 covers friction surfaces 4 of brake disk 1 and extends slightly into abutting surface regions for production-related reasons. Powder coating 7 consists of metal or other carbides, for example, which are embedded in a matrix of metal, for instance. In other words, powder coating 7 is a particle composite having a matrix containing intercalated carbide particles.

If an adhesion of coating 7 is better when cavities 6 are open, they remain open and only the lamellar graphite is removed.

A laser beam treatment is another option for removing the graphite component near the surface in the region of cavities 6 cut into, and thus opened, by the machining of friction surfaces 4. Using a laser beam, lamellar graphite 5 is sublimated in a near-surface region of friction surfaces 4 and the cast iron sealing cavities 6 is fused and then hardened again by cooling. In addition, a surface roughness may be increased by the laser beam treatment in order to improve the adhesion of powder coating 7 deposited subsequently. Surface coating 7 has high wear and corrosion resistance.

What is claimed is:

1. A brake element for a friction brake of a land vehicle, the brake element having cast iron including lamellar graphite, comprising:
a friction surface region;
wherein at least one of (i) in a selected area of the friction surface region, a graphite component of the cast iron decreases along a direction perpendicular to, and towards, the surface of the friction surface region, and (ii) cavities positioned in the cast iron in the selected area of the friction surface region are sealed along the surface of the friction surface region; and
wherein the friction surface region is provided with a coating.

2. The brake element as recited in claim 1, wherein the brake element undergoes an ultrasound treatment in the selected area of the friction surface region before the coating is applied, so that the graphite component of the cast iron is reduced on the surface and in a surface-near portion of the friction surface region.

3. The brake element as recited in claim 2, wherein the surface of the cast iron of the brake element undergoes a mechanical treatment in the selected area of the friction surface region following the ultrasound treatment and prior to applying the coating, so that cavities positioned in the cast iron in the selected area of the friction surface region are sealed.

4. The brake element as recited in claim 3, wherein the mechanical treatment of the surface of the cast iron of the brake element includes a blasting treatment in the selected area of the friction surface region before the coating is applied.

5. The brake element as recited in claim 1, wherein prior to applying the coating:
the brake element is subjected to a laser beam treatment in the selected area of the friction surface region, so that graphite at the surface of the selected area of the friction surface region is sublimated and the cast iron is fused at the surface; and
the surface of the cast iron of the brake element is sealed in the selected area of the friction surface region.

6. The brake element as recited in claim 5, wherein the laser beam treatment increases a surface roughness of the cast iron of the brake element in the selected area of the friction surface region in comparison with a surface of the cast iron of the brake element not subjected to a laser beam treatment.

7. The brake element as recited in claim 1, wherein the brake element is a brake disk.
